(19) United States
(12) Patent Application Publication
(10) Pub. No.: US 2006/0273268 A1
(43) Pub. Date: Dec. 7, 2006

(54) Method for detecting 3D measurement data using allowable error zone

(75) Inventors: Seock Hoon Bae, Gyeonggi (KR); Dong Hoon Lee, Seoul (KR); Seung Yob Kim, Seoul (KR); Sung Wook Cho, Gyeonggi (KR)

Correspondence Address: HARNESS, DICKEY & PIERCE, P.L.C., P.O. BOX 828, BLOOMFIELD HILLS, MI, 48303, US

(73) Assignee: INUS TECHNOLOGY, INC.

(21) Appl. No.: 11/284,182

(22) Filed: Nov. 21, 2005

(30) Foreign Application Priority Data
Jun. 7, 2005 (KR) 10-2005-0048311

(51) Int. Cl. G01N 21/86; G01V 8/00

(52) U.S. Cl. 250/559.19

(57) ABSTRACT

A method of detecting 3D measurement data using an allowable error zone is provided. The method detects 3D measurement data that corresponds to a preset measurement allowable error zone for each basic diagram when detecting 3D measurement data. For that purpose, a control unit generates auxiliary geometry data from a design data storage unit on the basis of analysis information of the design data; sets an allowable error zone for measurement in the auxiliary geometry data on the basis of allowable error information inputted from a user interface; controls a coordinate system of measurement data to coincide with a coordinate system of design data of the object; extracts candidate point groups included in the allowable error zone for measurement of the auxiliary geometry data from the measurement data; and fits the candidate point groups extracted from the candidate point groups included in the allowable error zone for measurement to output the fitted candidate point groups to the user interface.

### BACKGROUND OF THE INVENTION

1. Field of the Invention

The present invention relates to a method of automatically detecting 3-dimensional (3D) measurement data, and more particularly, to a method of detecting 3D measurement data that corresponds to a preset allowable error zone for each basic diagram when detecting 3D measurement data.

2. Description of the Related Art

Measurements using a 3D scanner can be performed using a contact method of directly contacting an object to be measured. Also, shape information of an object can be obtained using a non-contact method of digitally processing an image obtained by photographing the object using imaging equipment without physically contacting the object.

The measurement using a 3D non-contact type scanner is used for obtaining shape information of an object that is easily damaged when external force is applied to the object to be measured or a high-precision, small-sized component, as in cases of producing a semiconductor wafer, measuring a precise instrument, and recovering a 3D image.

Particularly, a 3D scanner has the advantage of more easily and precisely measuring digital image information where an optical device and a computer image processing technology are combined.

Particularly, measurement using the 3D non-contact type scanner is performed by seating a fixed object whose shape information is to be measured on a cradle and measuring the shape information of the object in a 3D non-contact manner using the scanner.

Also, when the shape information of an object is measured in a 3D non-contact manner, an operator must repeat the operation of rotating the object and measure the object at various angles with the scanner, so as to measure a dead zone that the light source of the scanner does not reach.

An operator or a designer (referred to as a user hereinafter) who has designed the object judges whether the above obtained 3D measurement data coincides with the original design data.

For example, when inspecting whether the diameter of a through hole formed in an object is within a tolerance range allowed by design data, a user measures the object using a 3D scanner to determine the size of the through hole, finds which part of the measured data is the collection of points that corresponds to the through hole that the user intends to measure, and compares the found part on the measured data with the diameter of the through hole in the design data.

However, the above related art measuring method has the problem of consuming much time in measuring an object because a user must manually select object points to be compared from measurement data.

Though a method of automatically selecting object points to be compared from measurement data is provided, there still exists the reliability problem of whether the selected points are actually points required for comparison.

Accordingly, a user cannot be certain whether the comparison result for the measurement data is accurate.

Therefore, the present applicant proposes a method of detecting 3D measurement data capable of exploring points that correspond to a reference geometry (basic diagram) from measurement data and ensuring the accuracy of the explored points.

### SUMMARY OF THE INVENTION

Accordingly, the present invention is directed to a method of detecting 3D measurement data using an allowable error zone that substantially obviates one or more problems due to limitations and disadvantages of the related art.

It is an object of the present invention to provide a method of detecting 3D measurement data using an allowable error zone capable of reliably locating points on measurement data that is to be matched to a relevant reference geometry so as to detect a reference geometry on the measurement data that corresponds to a reference geometry defined by the design data.

To accomplish the above object and other advantages, there is provided a method of automatically detecting 3D measurement data using an allowable error zone, the method including the steps of: generating, at a control unit, auxiliary geometry data from a design data storage unit where design data of an object to be measured is analyzed and stored on the basis of analysis information of the design data stored in the design data storage unit; setting, at the control unit, an allowable error zone for measurement in the auxiliary geometry generated from the analysis information of the design data on the basis of allowable error information inputted from a user interface; controlling, at the control unit, a coordinate system of measurement data measured by a 3D scanner for measuring the object to coincide with a coordinate system of design data of the object; extracting, at the control unit, candidate point groups included in the allowable error zone for measurement of the auxiliary geometry data from the measurement data; and fitting, at the control unit, the candidate point groups extracted from the candidate point groups included in the allowable error zone for measurement of the auxiliary geometry data from the measurement data using the auxiliary geometry, so as to output the fitted candidate point groups to the user interface.

The step of analyzing the design data may include the step of classifying the design data according to the geometric shape of the object.

The geometric shape may include at least one of: a point, a plane, a circle, a polygon, a vector, a slot, a sphere, a cylinder, a cone, a torus, an ellipse, and a box. The circle, the cylinder, the cone, and the torus may be formed so that the angle at which the allowable error zone starts and the angle at which the allowable error zone ends are set along a circumference thereof.

The allowable error zone is classified as a pipe shape and a disc shape according to the shape of the auxiliary geometry.

Also, in the case where the shape of the auxiliary geometry has the pipe shape, the pipe shape may be defined by assigning a radius to a boundary skeleton of the auxiliary geometry.

Also, in the case where the shape of the auxiliary geometry has the pipe shape, the pipe shape may be reduced using at least one of a length and a direction according to the shape of the auxiliary geometry.

Also, in the case where the shape of the auxiliary geometry has the disc shape, the disc shape may be defined by assigning a predetermined thickness to a plane defined by a boundary or a boundary skeleton of the auxiliary geometry.

Also, in the case where the shape of the auxiliary geometry has the disc shape, the disc shape may be reduced according to the width of the auxiliary geometry.

Also, the allowable error zone is set on the auxiliary geometry according to boundary value information inputted from the user interface.

Also, the step of fitting, at the control unit, the candidate point groups extracted from the candidate point groups included in the allowable error zone for measurement of the auxiliary geometry data from the measurement data using the auxiliary geometry so as to output the fitted candidate point groups to the user interface, may include the step of removing candidate points containing a measurement error from the candidate point groups.

The candidate point being moved may be at least one from a candidate point having an error value exceeding an allowed standard deviation, a candidate point having an error value located in a predetermined range from a candidate point showing the largest error value, and a candidate point having an error value of more than a predetermined value.

It is to be understood that both the foregoing general description and the following detailed description of the present invention are exemplary and explanatory and are intended to provide further explanation of the present invention as claimed.

### BRIEF DESCRIPTION OF THE DRAWINGS

The accompanying drawings, which are included to provide a further understanding of the present invention and are incorporated in and constitute a part of this application, illustrate embodiment(s) of the present invention and together with the description serve to explain the principle of the present invention. In the drawings:

FIG. 1 is a block diagram of a system for detecting 3D measurement data using an allowable error zone according to the present invention;

FIG. 2 is a flowchart of a method of detecting 3D measurement data using an allowable error zone according to the present invention;

FIG. 3 is an exemplary view of one embodiment of a method for detecting 3D measurement data using an allowable error zone of FIG. 2;

FIG. 4 is an exemplary view of manually setting a boundary plane of an allowable error zone at a design data plane of an auxiliary geometry;

FIG. 5 is an exemplary view of measurement data detected in the allowable error zone of FIG. 4;

FIG. 6 is an exemplary view of detecting candidate groups from measurement data by assigning an angle to an auxiliary geometry; and

FIG. 7 is an exemplary view of detecting measurement data from design data model.

### DETAILED DESCRIPTION OF THE PREFERRED EMBODIMENTS

Reference will now be made in detail to a preferred embodiment of the present invention.

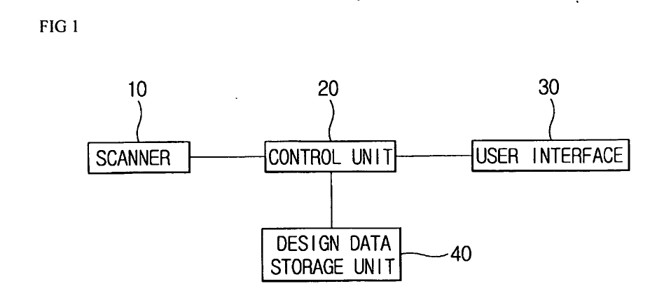

FIG. 1 is a block diagram of a system for detecting 3D measurement data using an allowable error zone according to the present invention.

Referring to FIG. 1, the system includes a scanner (10) for measuring an object to be measured, a control unit (20) for controlling the system on the whole, a user interface (30) for providing an interface with a user, and a design data storage unit (40) for storing design data of the object.

The scanner (10) is a device for measuring the object and obtaining measurement data. The scanner (10) may be a non-contact 3D scanner.

The control unit (20) analyzes the design data of the object, sets auxiliary geometry data for measurement from the design data of the object, sets an allowable error zone of the auxiliary geometry data for measurement on the basis of allowable error information inputted from a user interface (30), detects candidate point groups included in the allowable error zone from the measurement data, and outputs the detected candidate point groups to a relevant auxiliary geometry.

Also, the control unit (20) compares the design data with the measurement data and controls the position of the design data to coincide with the position of the measurement data.

The user interface (30) allows information (e.g., design data, auxiliary geometry data for measurement, measurement data, and allowable error zones) to be displayed and allows the allowable error information to be inputted so that the control unit may set the allowable error zone.

The design data storage unit (40) stores design data of the object designed by a user.

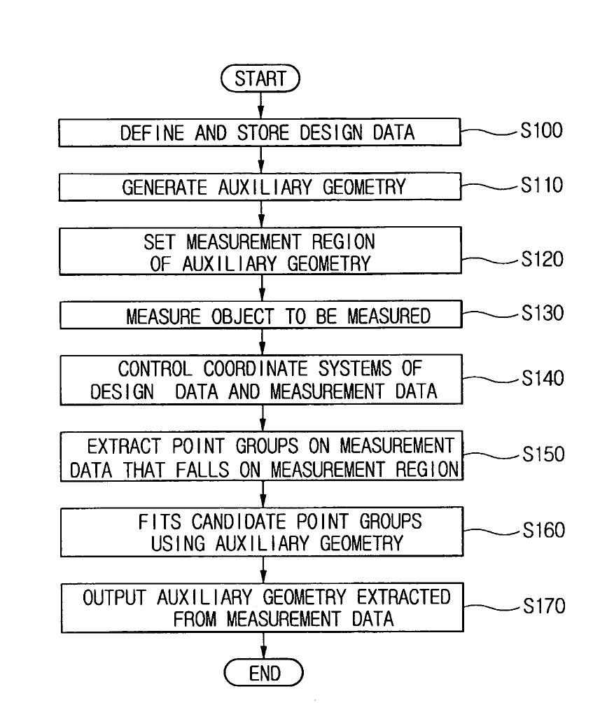

FIG. 2 is a flowchart of a method for detecting 3D measurement data using an allowable error zone according to the present invention. This method will be described with reference to FIGS. 1 and 2.

When the design data of an object to be measured is inputted through the user interface (30), the control unit (20) classifies the design data according to the geometric shape of the object and stores the classified design data in the design data storage unit (40) (S100).

In step S100, the control unit (20) classifies the object to be measured according to the geometric shape thereof. The classified geometric shape becomes a basic diagram when a measurement is performed. The classified geometric shape includes at least one of: a point, a plane, a circle, a polygon, a vector, a slot, a sphere, a cylinder, a cone, a torus, an ellipse, and a box.

After step S100 is performed, the control unit (20) displays the design data and the geometrical shape classified from the design data through the user interface (30) when the measurement of an object is requested through the user interface (30), and generates auxiliary geometry data for measurement according to auxiliary geometrical information inputted from the user interface (30) (S110).

After step S110 is performed, the control unit (20) detects allowable error information from the user interface (30) to set an allowable error zone for measurement in the auxiliary geometry (S120). Here, the allowable error zone (fitting zone) is a 3D space region for reliably locating points on the measurement data that will be fitted using an auxiliary geometry so as to calculate an auxiliary geometry on the measurement data that corresponds to the auxiliary geometry defined by the design data.

The allowable error zone is classified into a pipe shape or a disc shape according to the kind of auxiliary geometry. The pipe shape is defined by assigning a radius to a boundary skeleton of a relevant auxiliary geometry, and the disc shape is defined by assigning a thickness to plane information defined by a boundary plane or a boundary skeleton.

The allowable error zone has a basic zone defined by a radius and a thickness according to the shape of the auxiliary geometry and has an offset value and a reduction rate so as to more precisely control the allowable error zone.

The offset value controls the radius or the thickness of the auxiliary geometry, and the thickness can be controlled in both directions.

Also, the reduction rate controls the size of the pipe along a length direction when the shape of the auxiliary geometry is the pipe shape and controls the width of the disc when the shape of the auxiliary geometry is the disc shape.

However, in the case where the auxiliary geometry has a cylindrical shape, the auxiliary geometry has an allowable error zone of a disc shape, but the reduction rate controls the length of the cylinder in an axial direction.

The auxiliary geometry can have the allowable error zones as shown in Table 1.

TABLE 1

| | Pipe | Disc |
|---|---|---|
| Point | ◯ | X |
| Vector | ◯ | X |
| Circle | ◯ | ◯ |
| Plane | ◯ | ◯ |
| Cylinder | X | ◯ |
| Sphere | X | ◯ |
| Cone | X | ◯ |
| Torus | X | ◯ |
| Box | X | ◯ |
| Ellipse | ◯ | ◯ |
| Slot | ◯ | ◯ |
| Polygon | ◯ | ◯ |

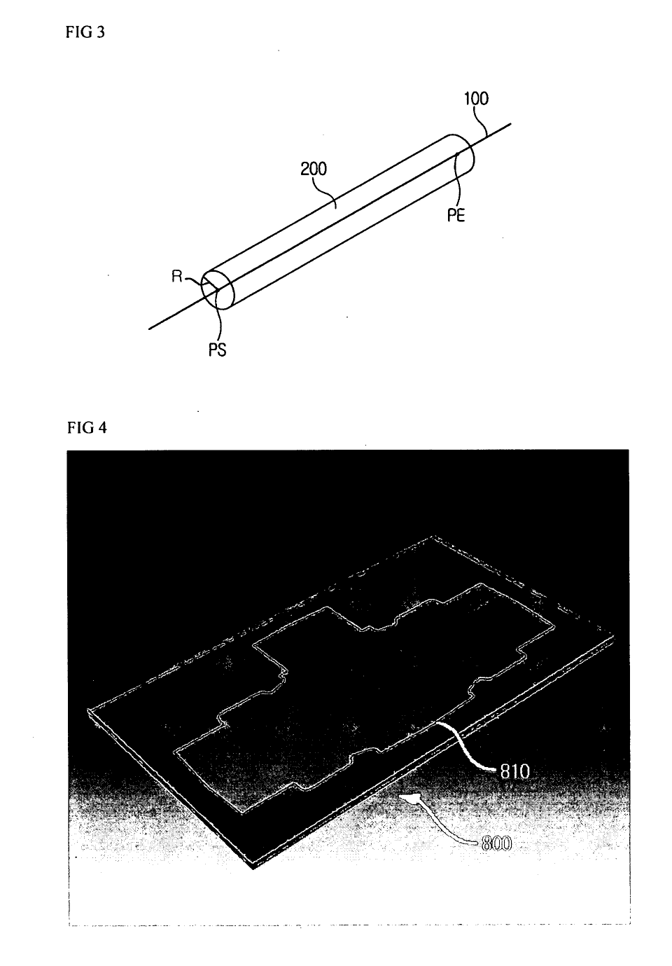

FIG. 3 is an exemplary view of one embodiment of setting an allowable error zone so as to detect 3D measurement data.

Referring to FIG. 3, an allowable error zone (200) of the first auxiliary geometry (100) is configured in the following way. The length of the allowable error zone (200) is set by a start point ‘PS’ and an end point ‘PE’, and the radius ‘R’ of the allowable error zone (200) is set by an offset value.

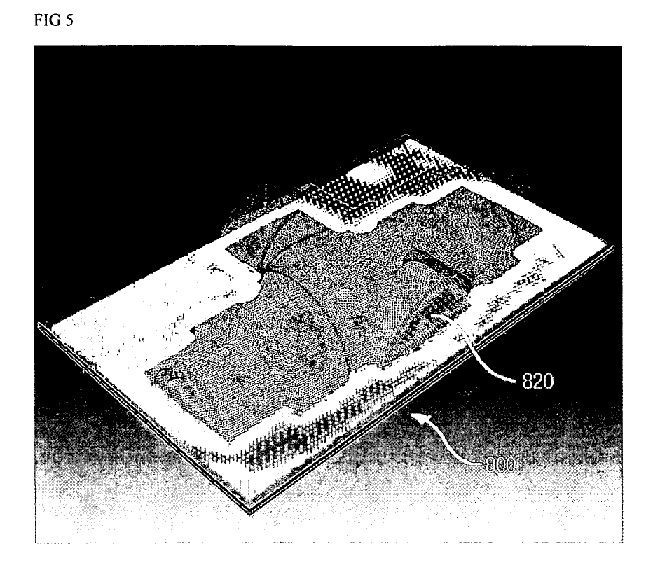

FIG. 4 is an exemplary view of manually setting a boundary plane of an allowable error zone at a design data plane of an auxiliary geometry, and FIG. 5 is an exemplary view of measurement data detected in the allowable error zone of FIG. 4.

Referring to FIGS. 4 and 5, it is possible to define a design data plane of the fourth auxiliary geometry (800) where the allowable error zone is generated and to select point groups on measurement data that will be used for fitting using boundary information of the design data plane of the fourth auxiliary geometry (800).

Also, a user can interactively illustrate the boundary plane (810) of the allowable error zone on the fourth geometry (800) even though the design data plane is not present, so that a more accurate candidate point group (820) can be detected.

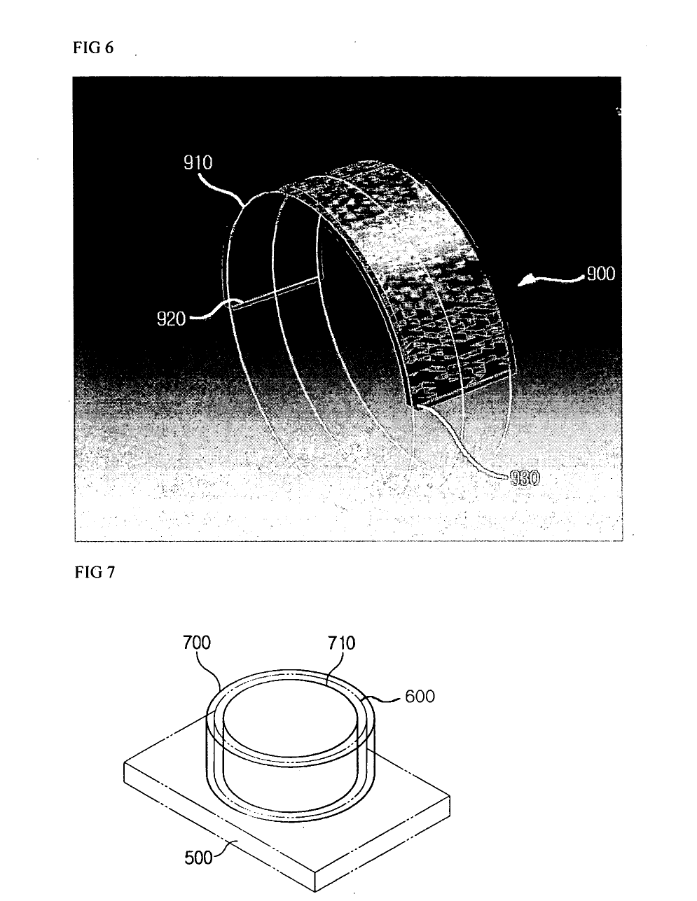

Also, it is possible to define a start angle at which an allowable error zone starts and an end angle at which an allowable error zone ends in auxiliary geometries such as a circle, a cylinder, a cone, and a torus, so that a user can select fitting candidate point groups more accurately. Referring to FIG. 6, the fifth auxiliary geometry (900) has a cylindrical shape and a user sets one side of the fifth auxiliary geometry (900) to a start angle (920) and sets the other side of the fifth auxiliary geometry (900) to an end angle so as to set the third allowable error zone (910) required for measurement.

After step S120 is performed, the control unit (20) detects the measurement data of an object measured in step S130 by the scanner (10) and controls the coordinate system of the measurement data to coincide with the coordinate system of the design data of the object in step S140. In step S140, the controlling of coincidence of the two coordinate systems is performed using conventional technology.

After step S140 is performed, the control unit (20) extracts candidate point groups included in the allowable error zone for the measurement of the auxiliary geometry from the measurement data in step S150.

FIG. 7 is an exemplary view of detecting measurement data from a design data model. A method of extracting the candidate point groups will be described with reference to FIG. 7. In the case where candidate point groups of the third auxiliary geometry (600) are detected from the measurement data, where the third auxiliary geometry (600) having a cylindrical shape is formed on the second auxiliary geometry (500), the allowable error zone set in step S120 includes an allowable error zone (700) set at the outer side of the third auxiliary geometry (600) and an allowable error zone (710) set at the inner side of the third auxiliary geometry (600).

At this point, the allowable error zones (700 and 710) of the third auxiliary geometry (600) having a cylindrical shape are set to the pipe shape and the disc shape (as shown in Table 1), and the allowable error zones (700 and 710) are set according to the length and the radius of the cylinder as described above. The control unit (20) detects all of the candidate point groups included in the allowable error zones (700 and 710) from the measurement data.

After step S150 is performed, the control unit (20) removes candidate point groups containing a measurement error from the candidate point groups detected in step S1150, performs a fitting using a relevant auxiliary geometry in step S160, and displays the auxiliary geometry of the measurement data fitted in step S160 to the user interface (30) in step S170.

The candidate point groups that are removed because they contain the measurement error in step S160 include a candidate point having an error value exceeding an allowed standard deviation, a candidate point having an error value located in a predetermined range (the upper 10% from a reference candidate point showing a largest error value) from a candidate point showing a largest error value, and a candidate point having an error value of more than a predetermined value.

Also, it is possible to use only a predetermined portion of the detected candidate points.

Therefore, it is possible to obtain desired data from the measurement data more accurately and swiftly by setting the allowable error zone in the auxiliary geometry of the design data.

As described above, the present invention has the advantage of measuring the difference between design data and measurement data accurately and swiftly when a user inspects a product.

Also, product inspection can be automated to improve its efficiency.

The foregoing embodiment is merely exemplary and is not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. A method of automatically detecting 3D (3-dimensional) measurement data using an allowable error zone, the method comprising the steps of:
(a) generating, at a control unit, an auxiliary geometry from a design data storage unit where design data of an object to be measured is analyzed and stored on the basis of analysis information of the design data stored in the design data storage unit;
(b) setting, at the control unit, an allowable error zone for measurement in the auxiliary geometry generated in the step (a) on the basis of allowable error information inputted from a user interface;
(c) controlling, at the control unit, a coordinate system of measurement data measured by a 3D scanner for measuring the object to coincide with a coordinate system of design data of the object;
(d) extracting, at the control unit, candidate point groups included in the allowable error zone for measurement of the auxiliary geometry from the measurement data; and
(e) fitting, at the control unit, the candidate point groups extracted in the step (d) using the auxiliary geometry to output the fitted candidate point groups to the user interface.

2. The method according to claim 1, wherein the step of analyzing the design data in the step (a) comprises the step of classifying the design data according to the geometric shape of the object.

3. The method according to claim 2, wherein the geometric shape comprises at least one of a point, a plane, a circle, a polygon, a vector, a slot, a sphere, a cylinder, a cone, a torus, an ellipse, and a box.

4. The method according to claim 3, wherein the circle, the cylinder, and the torus are formed such that an angle at which the allowable error zone starts and an angle at which the allowable error zone ends are set along a circumference thereof.

5. The method according to claim 1, wherein the allowable error zone in the step (b) is classified into a pipe shape and a disc shape according to a shape of the auxiliary geometry.

6. The method according to claim 5, wherein the pipe shape is defined by assigning a radius to a boundary skeleton of the auxiliary geometry.

7. The method according to claim 5, wherein the pipe shape is reduced using at least one of a length and a direction according to a shape of the auxiliary geometry.

8. The method according to claim 5, wherein the disc shape is defined by assigning a predetermined thickness to a plane defined by a boundary or a boundary skeleton of the auxiliary geometry.

9. The method according to claim 5, wherein the disc shape is reduced according to a width of the auxiliary geometry.

10. The method according to claim 1, wherein the allowable error zone in the step (b) is set on the auxiliary geometry according to boundary value information inputted from a user interface.

11. The method according to claim 1, wherein the step (e) comprises the step of removing candidate points containing a measurement error from the candidate point groups.

12. The method according to claim 11, wherein the candidate point being moved is at least one of a candidate point having an error value exceeding an allowed standard deviation, a candidate point having an error value located in a predetermined range from a candidate point showing a largest error value, and a candidate point having an error value of more than a predetermined value.
